(19) United States
(12) Patent Application Publication
(10) Pub. No.: US 2004/0193715 A1
(43) Pub. Date: Sep. 30, 2004

(54) Scheduling of host-initiated transactions

(76) Inventors: Daniel S. Froelich, Beaverton, OR (US); John S. Howard, Portland, OR (US)

Correspondence Address: BUCKLEY, MASCHOFF, TALWALKAR LLC, 5 ELM STREET, NEW CANAAN, CT, 06840, US

(21) Appl. No.: 10/401,006

(22) Filed: Mar. 27, 2003

(51) Int. Cl. G06F 15/16

(52) U.S. Cl. 709/227

(57) ABSTRACT

According to some embodiments, a device is provided to determine a plurality of clients, determine one or more of the plurality of clients that are ready to communicate, and sequentially provide service to each of the determined one or more clients.

### BACKGROUND

According to host-centric communication architectures, a host initiates communication with its clients in order to provide services to the clients. One such architecture is the Universal Serial Bus (USB) architecture. The USB architecture provides for host-initiated periodic and asynchronous communication with clients. Periodic data streams are associated with explicit bandwidth allocations, and any remaining bandwidth is shared by asynchronous data streams.

Policies for servicing asynchronous data streams vary across host implementations. According to one typical policy, a host executes a transaction, in turn, with a first data stream requiring service, a second data stream requiring service, and so on until a last data stream requiring service. The host then executes a transaction with the first data stream and continues as described above, thereby effecting a “round robin” service policy.

Conventional asynchronous service policies consume bandwidth inefficiently. These policies are particularly inefficient for wireless architectures due to high transaction latency and error rates.

### BRIEF DESCRIPTION OF THE DRAWINGS

FIG. 1 is a block diagram of a system according to some embodiments.

FIG. 2 is a flow diagram of process steps according to some embodiments.

FIG. 3 is a block diagram of a controller board according to some embodiments.

FIG. 4 is a tabular representation of stored data according to some embodiments.

FIG. 5 is a flow diagram of process steps according to some embodiments.

FIG. 6 is a flow diagram of process steps according to some embodiments.

### DETAILED DESCRIPTION

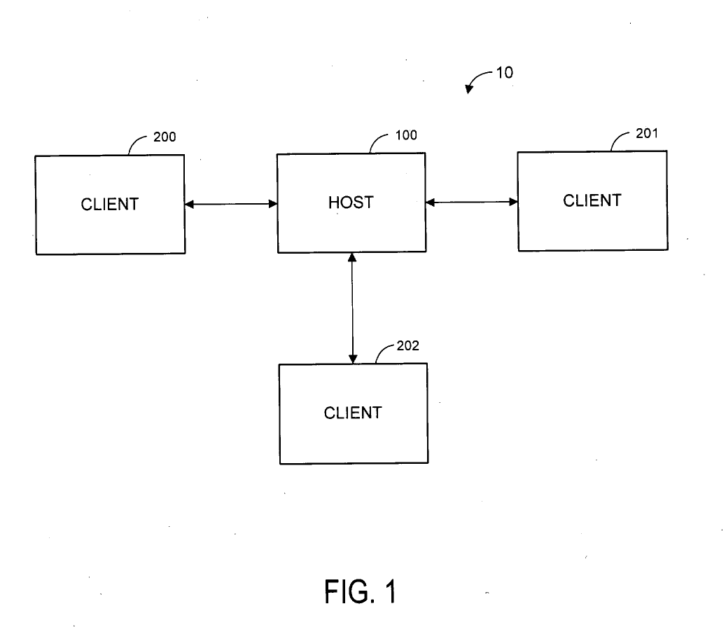

FIG. 1 is a block diagram of communication network 10. Communication network 10 comprises host 100 and clients 200 through 202. Host 100 may comprise any element or elements for providing services to clients, including devices such as a personal computer, a personal digital assistant, a cellular telephone, a motherboard, an expansion card, and a host controller. Host 100 may also comprise any combination of software and hardware elements. A dedicated host is not used in some embodiments, and one of clients 200 through 202 is elected to perform the duties attributed to host 100 herein.

Clients 200 through 202 may comprise peripheral devices such as a mouse, a keyboard, and external storage that communicate with host 100 via a host-centric communication protocol. In some embodiments, clients 200 through 202 communicate with host 100 according to the USB architecture. Clients 200 through 202 may also comprise any combination of devices, hardware and software.

Communication links between host 100 and clients 200 through 202 may be any combination of any readable media for transferring data, and need not be identical to one another. Possible media include coaxial cable, twisted-pair wires, fiber-optics, RF signals, and infrared signals. Moreover, although each link appears dedicated, the links in some embodiments are shared among two or more of clients 201 through 203 and/or other unshown elements.

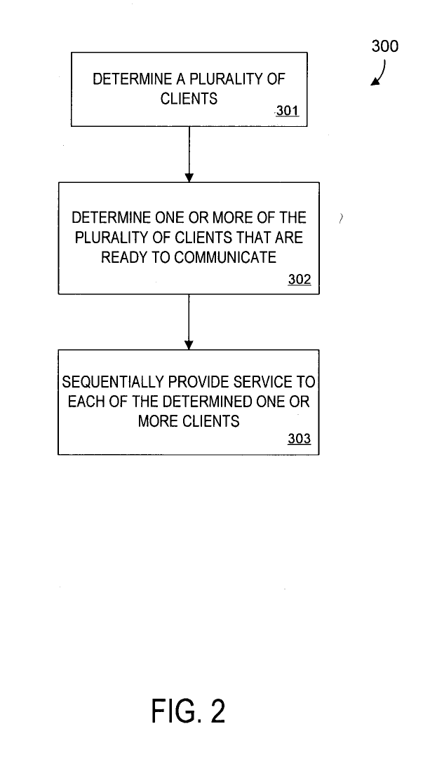

FIG. 2 is a flow diagram of process 300 that may be executed by host 100 according to some embodiments. Process 300 may be embodied by any combination of hardware or software. In some embodiments, process 300 is embodied by software code that is executed by a controller of host 100. Process 300 may provide host/client communication that is more efficient than previously available.

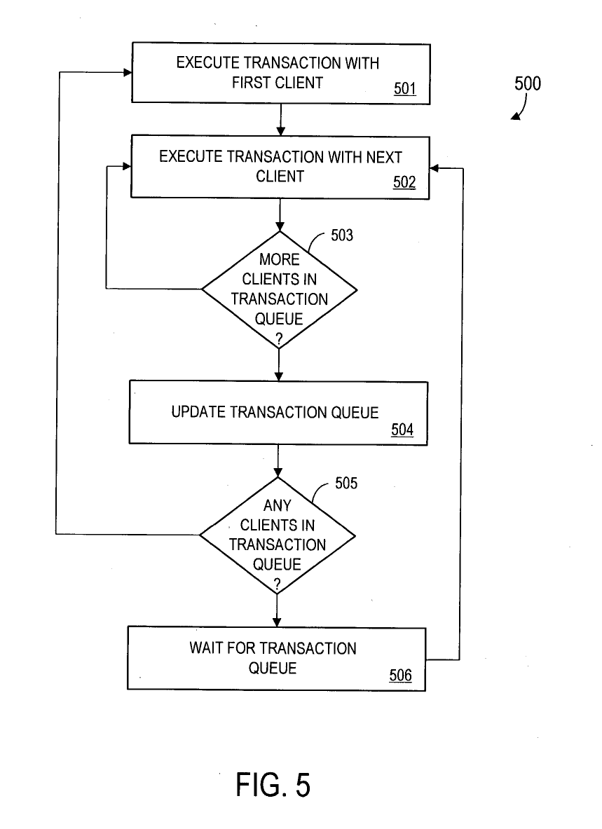

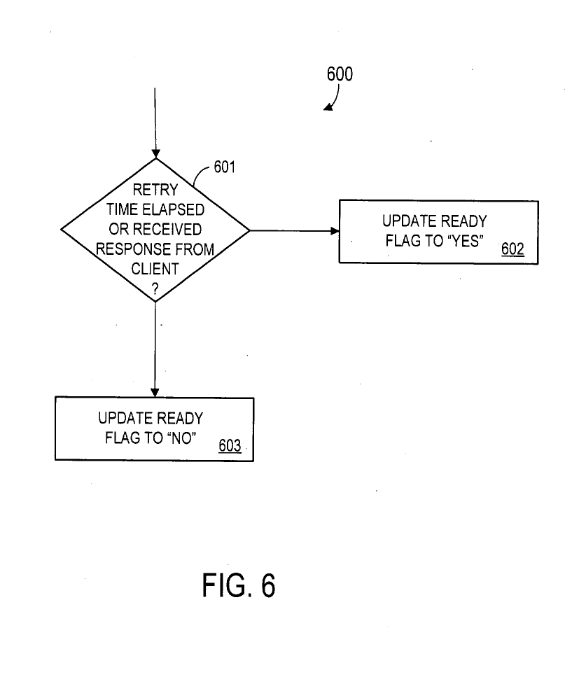

A plurality of clients is initially determined at 301. The plurality of clients may consist of clients that require service from host 100. Next, at 302, one or more of the plurality of clients that are ready to communicate are determined. This determination may be based on whether a USB flow-control signal was received from the one or more clients. A service is then sequentially provided to each of the determined one or more clients at 303. Further details of process 300 according to some embodiments will be provided below with respect to FIGS. 5 and 6.

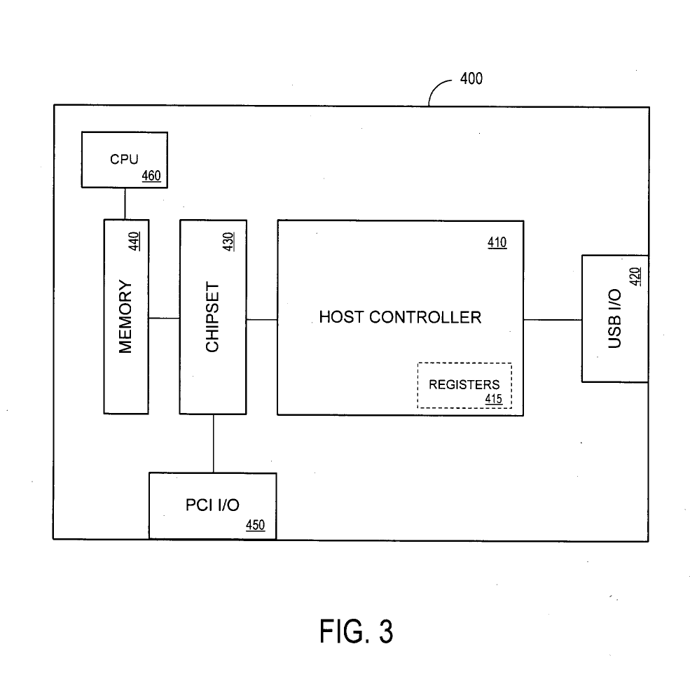

FIG. 3 is a block diagram of controller board 400 according to some embodiments. In this regard, controller board 400 may implement host 100 of FIG. 1. Controller board 400 comprises host controller 410, which may execute code stored on a readable medium to provide a host according to some embodiments. Host controller 410 comprises a USB host controller according to some embodiments.

Host controller 410 comprises memory registers 415. Memory registers 415 may provide a high-speed dedicated storage area to functional elements of host controller 410. More particularly, memory registers 415 may store data representing a transaction queue that is used to schedule communications with clients according to some embodiments.

USB interface 420 is coupled to host controller 410 and supports a medium over which controller card 400 communicates with clients 200 through 202. Accordingly, data is transmitted to and received from clients 200 through 202 via USB interface 420. USB interface 420 may be substituted for an interface that supports a different medium and protocol over which controller card 400 may communicate.

Chipset 430 is coupled to host controller 410 to provide communication between host controller 410, memory 440 and Peripheral Component Interconnect (PCI) interface 450. Memory 440 may comprise a Programmable Read Only Memory (PROM) or a Random Access Memory (RAM) such as a single data rate RAM or a double data rate RAM for storing data and/or code for use by host controller 410. Memory 440 may also provide data and/or code to CPU 460 for use in controlling controller card 400.

PCI interface 450 is used to communicate over a standard PCI interface with a device in which controller board 400 is installed, such as a personal computer. In some embodiments, the device executes client driver software and instructs host controller 410 to provide services to one or more of clients 200 through 203.

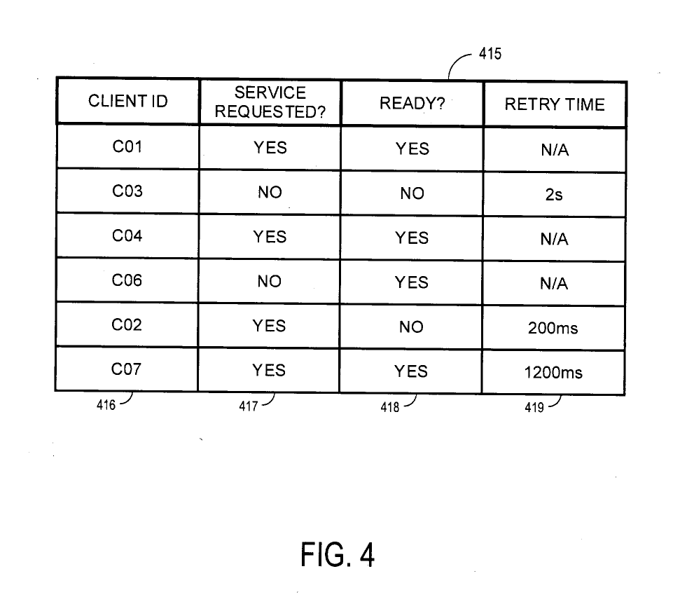

FIG. 4 is a tabular representation of a portion of registers 415 according to some embodiments. The tabular representation comprises several records, each of which includes three fields. The fields include Client Id field 416, Service Requested? field 417, Ready? field 418, and Retry Time field 419.

Client Id field 416 of a record specifies a client data stream that is associated with the record. Service Requested field 417 includes a flag specifying whether services have been requested for the associated data stream. As described above, this flag may be updated based on commands received over PCI interface 460 from client driver software.

Ready? field 418 also includes a flag. The flag indicates whether the associated data stream is ready to communicate with host 100. Therefore, client data streams that are associated with a “Yes” flag in Ready? field 418 comprise a transaction queue to which services are sequentially provided in step 303 of process steps 300. A client may be removed from the transaction queue by changing its associated flag in Ready? field 418 from “Yes” to “No”. Ready? field 418 associated with a client data stream may be changed from “Yes” to “No” if a “not ready” signal was received from the client data stream. According to the USB architecture, the “not ready” signal may be implemented by a flow-control signal sent from the client to host 100. A client may also be removed from the transaction queue by changing its associated flag in Service Requested? field 417 from “Yes” to “No”.

A client is added to the transaction queue by changing its associated flag in Ready? field 418 from “No” to “Yes”. In some embodiments, a flag of Ready? field 418 is changed from “No” to “Yes” in a case that a threshold time has elapsed since the flag was changed from “Yes” to “No”. This threshold time may be specified in the configuration of host controller 410, and/or may be received from a client associated with the flag. As an example of the latter case, a client that is not ready to communicate with host 100 may transmit a “not ready” signal along with an indication of a time after which the client will be ready to communicate. A flag of Ready? field 418 may also be changed from “No” to “Yes” in a case that a “ready” signal is received from a client data stream.

In some embodiment, a flag of Ready? field 418 may be changed from “Yes” to “No” in a case that a client does not respond to host 100 within a threshold time. Again, this threshold time may be specified in the configuration of host controller 410, and/or may be received from a client that is associated with the flag.

Retry Time field 419 indicates a threshold time at which an associated client should be considered ready to communicate. As mentioned above, the time may be determined based on an indication received from the associated client or based on a predetermined time. The time may be specified in Retry Time field 419 in terms of an amount of time from a current time, an actual clock time, a number of bus frames, or any other convention for indicating a time.

The tabular illustration of registers 415 merely represents relationships between stored information. A number of other arrangements may be employed besides that shown. It is further contemplated that register 415 may include more records than those shown and that each record may be associated with fields other than those illustrated.

FIG. 5 is a flow diagram of process 500 according to some embodiments. Process 500 may be embodied in software that is read from a computer-readable medium such as a floppy disk, a CD-ROM, a DVD-ROM, a Zip™ disk, a magnetic tape, or a signal, and stored in a memory in communication with host controller 410.

Process 500 may be stored in a compressed, uncompiled and/or encrypted format. In some embodiments, hard-wired circuitry may be used in place of, or in combination with, processor-executable code for implementation of processes according to some embodiments. Moreover, although process 500 is described below with respect to host controller 410, some embodiments may be implemented by one or more other elements.

Prior to 501, host controller 410 receives service requests associated with a plurality of clients. The service requests may be received from software drivers that are executed by a microprocessor of a device in which controller board 400 is installed. Service Request? field 417 is updated to specify those client data streams for which a service request has been received. The service requests need not be received simultaneously. Rather, field 417 may be periodically updated to indicate clients for which service requests have been received and not yet satisfied.

These clients are then used to determine a transaction queue. More specifically, a transaction queue is determined to include one or more clients for which service requests have been received and not yet satisfied (identified by “Yes” in field 417), and which are ready to communicate with host controller 410 (identified by “Yes” in field 418). According to registers 415 of FIG. 4, the transaction queue consists of clients “C01”, “C04” and “C07”.

In some embodiments, provision of a service to a client requires execution of several distinct transactions with the client. Therefore, at 501, host controller 410 executes a transaction with a first client of the transaction queue. Host controller 410 then executes a transaction with a next client of the transaction queue at 502. According to the present example, 501 and 502 are performed with respect to clients “C01” and “C04”, respectively.

It is determined at 503 whether the transaction queue includes additional clients. Since client “C07” has not yet been serviced, flow returns to 502, in which a transaction is executed with client “C07”. Upon returning to 503, flow continues to 504 because the end of the transaction queue has been reached.

The transaction queue is updated at 504. In some embodiments of 504, host controller 410 determines whether any outstanding service requests have been satisfied. For each such request, an associated flag of Service Request field 417 is changed from “Yes” to “No”. As a result, an associated client is removed from the transaction queue.

According to some embodiments of 504, Retry Time field 419 is examined for each record in which Ready? field 418 specifies “No”. If the time indicated in field 419 has elapsed, Ready? field 418 is changed to specify “Yes”. Such a change will add an associated client to the transaction queue if the associated Service Request field 417 specifies “Yes”. A client may also be added to the transaction queue at 504 if host controller 410 receives a service request associated with the client, and if Ready? field 418 associated with the client specifies “Yes”.

At 505, it is determined whether the transaction queue includes any clients. Such a determination may include determining if any clients are associated in register 415 with “Yes” flags in fields 417 and 418. If so, flow returns to 501 and proceeds as described above so as to sequentially execute a transaction with each client in the transaction queue. If the transaction queue contains no clients, flow pauses at 506 until a client is added to the transaction queue. Flow returns to 501 once a client is added to the transaction queue.

Some embodiments may differ in whole or in part from process 500. In one example, the transaction queue is updated continuously as flow cycles through 501, 502, 503, 505 and 506. In other examples, the transaction queue may contain all clients that are associated with outstanding service requests, even if one or more of the clients are not ready to communicate. A host may determine whether a client of such a transaction queue is ready to communicate prior to executing a transaction with the client. If the client is not ready to communicate, the host may proceed to a next client in the queue without attempting to execute a transaction with the “not ready” client.

FIG. 6 is a flow diagram of process 600 to update the ready state of a client according to some embodiments. A host may execute process 600 with respect to each client that is associated with an outstanding service request. In some embodiments, the host executes process 600 with respect to each client that is registered with the host. Process 600 may be executed in whole or in part by one or more elements other than a host. In the latter case, a ready state of a client may be transmitted to the host by the one or more elements. Process 600 may be performed simultaneously with process 500 so as update ready state information that is used during execution of process 500.

Two events are initially monitored at 601. First, it is determined whether a retry time associated with the client has elapsed. Second, it is determined whether a response has been received from the client. Flow pauses at 601 until either of the two events has occurred. In the meantime, the flag of associated Ready? field 418 indicates the state of the client.

A retry time associated with the client is retrieved from registers 415 for the first determination of 601. The retrieved retry time is used to determine whether the retry time has elapsed. Using the convention shown in FIG. 4, the retry time is determined to have elapsed if the associated retry time is zero. In a case that the retry time associated with the client is an actual time, it is determined at 601 whether the retry time has been reached. If the retry time has elapsed, the flag of associated Ready? field 418 is changed to “Yes” at 602 and flow returns to 601.

Flow also proceeds to 602 from 601 if a response is received from the client indicating that the client is ready to communicate. If a received response indicates that the client is not ready to communicate, flow continues to 603. The flag of associated Ready? field 418 is changed to “No” at 603 to indicate that the client is not ready to communicate. In some embodiments, the “not ready” response may be accompanied by an indication of a time after which the client will be ready to communicate. This time may be used to update associated Retry Time field 419 at603. Flow returns to 601 from 603 and continues as described above.

Process 500 and process 600 and backwards-compatible with current host-centric protocols such as USB according to some embodiments. In other words, processes attributed to a host herein may be compatible with existing USB client state machines. Accordingly, some embodiments may be implemented in a communication system by implementing process 500 and process 600 in a host and by allowing associated clients to operate according to an existing host-centric protocol.

The several embodiments described herein are solely for the purpose of illustration. Embodiments may include any currently or hereafter-known versions of the elements described herein. Therefore, persons skilled in the art will recognize from this description that other embodiments may be practiced with various modifications and alterations.

What is claimed is:

1. A method comprising:
determining a plurality of clients;
determining one or more of the plurality of clients that are ready to communicate; and
sequentially providing service to each of the determined one or more clients.

2. A method according to claim 1, wherein the determined one or more clients comprise a transaction queue, the method further comprising:
determining that one of the one or more clients is not ready to communicate; and
removing the determined one of the one or more clients from the transaction queue.

3. A method according to claim 2, wherein determining that the one of the one or more clients is not ready to communicate comprises:
receiving a “not ready” signal from the one client.

4. A method according to claim 3, further comprising:
receiving, from the one client, an indication of a time after which the one client will be ready to communicate;
determining that the time has elapsed; and
adding the one client to the transaction queue.

5. A method according to claim 2, further comprising:
determining that a threshold time has elapsed; and
adding the one client to the transaction queue.

6. A method according to claim 2, further comprising:
receiving a “ready” signal from the one client; and
adding the one client to the transaction queue.

7. A method according to claim 1, wherein the determined one or more clients comprise a transaction queue, the method further comprising:
determining that a threshold time has elapsed; and
adding a second one of the plurality of clients to the transaction queue.

8. A method according to claim 1, wherein the determined one or more clients comprise a transaction queue, the method further comprising:
receiving a “ready” signal from a second one of the plurality of clients; and
adding the second one of the plurality of clients to the transaction queue.

9. A method according to claim 1, further comprising:
receiving, from a second one of the plurality of clients, an indication of a time after which the second client will be ready to communicate;
determining that the time has elapsed; and
adding the second client to the transaction queue.

10. A method according to claim 1, wherein sequentially providing service to each of the determined one or more clients comprises:
determining whether a first client of the one or more clients is ready to communicate;
executing a first transaction with the first client device if it is determined that the first client device is ready to communicate;
determining whether a second client device of the one or more clients is ready to communicate; and
execute a second transaction with the second client device if it is determined that the first client device is ready to communicate.

11. A medium storing processor-executable process steps, the process steps comprising:
a step to determine a plurality of clients;
a step to determine one or more of the plurality of clients that are ready to communicate; and
a step to sequentially provide service to each of the determined one or more clients.

12. A medium according to claim 11, wherein the determined one or more clients comprise a transaction queue, the process steps further comprising:
a step to determine that one of the one or more clients is not ready to communicate; and
a step to remove the determined one of the one or more clients from the transaction queue.

13. A medium according to claim 12, wherein the step to determine that the one of the one or more clients is not ready to communicate comprises:
a step to receive a “not ready” signal from the one client.

14. A medium according to claim 13, the process steps further comprising:
a step to receive, from the one client, an indication of a time after which the one client will be ready to communicate;
a step to determine that the time has elapsed; and
a step to add the one client to the transaction queue.

15. A medium according to claim 11, the process steps further comprising:
a step to receive, from a second one of the plurality of clients, an indication of a time after which the second client will be ready to communicate;
a step to determine that the time has elapsed; and
a step to add the second client to the transaction queue.

16. A medium according to claim 11, wherein the step to sequentially provide service to each of the determined one or more clients comprises:
a step to determine whether a first client of the one or more clients is ready to communicate;
a step to execute a first transaction with the first client if it is determined that the first client is ready to communicate;
a step to determine whether a second client of the one or more clients is ready to communicate; and
a step to execute a second transaction with the second client if it is determined that the second client is ready to communicate.

17. A device to:
determine a plurality of clients;
determine one or more of the plurality of clients that are ready to communicate; and
sequentially provide service to each of the determined one or more clients.

18. A device according to claim 17, wherein the determined one or more clients comprise a transaction queue, the device further to:
determine that one of the one or more clients is not ready to communicate; and
remove the determined one of the one or more clients from the transaction queue.

19. A device according to claim 18, wherein the determination that the one of the one or more clients is not ready to communicate comprises reception of a “not ready” signal from the one client.

20. A device according to claim 19, the device further to:
receive, from the one client, an indication of a time after which the one client will be ready to communicate;
determine that the time has elapsed; and
add the one client to the transaction queue.

21. A device according to claim 17, the device further to:
receive, from a second one of the plurality of clients, an indication of a time after which the second client will be ready to communicate;
determine that the time has elapsed; and
add the second client to the transaction queue.

22. A device according to claim 17, wherein the sequential provision of service to each of the determined one or more clients comprises:
determination of whether a first client of the one or more clients is ready to communicate;
execution of a first transaction with the first client if it is determined that the first client is ready to communicate;
determination of whether a second client of the one or more clients is ready to communicate; and
execution of a second transaction with the second client if it is determined that the second client is ready to communicate.

23. A device comprising:
a memory storing processor-executable process steps; and
a processor in communication with the memory and operative in conjunction with the stored process steps to:
determine a plurality of clients;
determine one or more of the plurality of clients that are ready to communicate; and
sequentially provide service to each of the determined one or more clients.

24. A device according to claim 23, wherein the determined one or more clients comprise a transaction queue, the processor further operative in conjunction with the stored process steps to:
determine that one of the one or more clients is not ready to communicate; and
remove the determined one of the one or more clients from the transaction queue.

25. A device according to claim 24, wherein the determination that the one of the one or more clients is not ready to communicate comprises reception of a “not ready” signal from the one client.

26. A device according to claim 25, the processor further operative in conjunction with the stored process steps to:
receive, from the one client, an indication of a time after which the one client will be ready to communicate;
determine that the time has elapsed; and
add the one client to the transaction queue.

27. A device according to claim 23, the processor further operative in conjunction with the stored process steps to:
receive, from a second one of the plurality of clients, an indication of a time after which the second client will be ready to communicate;
determine that the time has elapsed; and
add the second client to the transaction queue.

28. A device according to claim 23, wherein the sequential provision of service to each of the determined one or more clients comprises:
determination of whether a first client of the one or more clients is ready to communicate;
execution of a first transaction with the first client if it is determined that the first client is ready to communicate;
determination of whether a second client of the one or more clients is ready to communicate; and
execution of a second transaction with the second client if it is determined that the second client is ready to communicate.

29. A system comprising:
a host controller to determine a plurality of clients, to determine one or more of the plurality of clients that are ready to communicate, and to sequentially provide service to each of the determined one or more clients; and
a Universal Serial Bus interface coupled to the host controller.

30. A system according to claim 29, further comprising:
a chipset coupled to the host controller; and
an SDRAM coupled to the chipset.
